(19) United States
(12) Patent Application Publication
(10) Pub. No.: US 2013/0289879 A1
(43) Pub. Date: Oct. 31, 2013

(54) PROCESS FOR CHARACTERISING THE EVOLUTION OF A RESERVOIR

(71) Applicant: Andrea Grandi, Sola (NO)

(72) Inventor: Andrea Grandi, Sola (NO)

(73) Assignee: Total S.A., Paris La Defense Cedex (FR)

(21) Appl. No.: 13/635,463

(22) PCT Filed: Apr. 1, 2011
(86) PCT No.: PCT/EP2011/055097

§ 371 Date: May 2, 2013

(30) Foreign Application Priority Data
Apr. 6, 2010 (GB) 1005646.3

(51) Int. Cl. G01V 1/30

(52) U.S. Cl. CPC G01V 1/308
USPC 702/6; 702/14; 702/18

(57) ABSTRACT

The application discloses a process and apparatus for characterising the evolution of a reservoir by co-analyzing the changes in the propagation times and seismic amplitudes of seismic reflections. The method comprising the steps of: providing a base survey of the reservoir with a set of seismic traces at a first time; and providing a monitor survey of the reservoir, taken at a second time, with a set of seismic traces associated to the same positions as in the base survey. The evolution of the reservoir is then characterised by inversion to obtain an estimate of the changes having occurred in the time interval between base and monitor surveys, the inversion being performed using at least some seismic traces for which no assumption is made that the energy is propagating vertically. In a main embodiment, inversion is performed by minimising a function which includes a term dependent on the incident angle of the seismic reflections.

The present invention relates generally to the field of geosciences and more particularly to seismic data processing. Specifically the invention relates to a method to extract the time-lapse changes in 3D seismic data sets collected over a production period to integrate with production data and assist in understanding and managing the extraction of oil and/or gas from reservoirs or the injection of other fluids into the reservoirs.

In the oil and gas industry, seismic surveys are carried out in order to provide subsurface images so that accumulations of hydrocarbons or other fluids might be identified. In a seismic survey, one or several sources emit elastic waves in the form of pressure or ground motion modulation from specific locations (wavefield), at or below the land or sea surface or in a borehole. This wavefield propagates away from the source(s) through the subsurface. Along with this propagation, a fraction of the incident wavefield is reflected from the heterogeneities in the elastic material properties of the subsurface (such as acoustic impedance). This excitation by the incident wavefield generates a reflected wavefield from the heterogeneities, which manifests as pressure, particle motion or some derived quantities and can be detected and recorded at the surface or in a borehole at a number of receiver locations.

Processing of the measurements is undertaken so as to construct a 3D image of the sub-surface. Repeated surveys at selected time intervals (days, months, years) allow observation of the changes in, over or under a given reservoir across the time interval—e.g. before oil or gas production starts and after some period of production or injection and to compare the results of measurements. This is called 4D seismic and involves comparing 2D or 3D seismic surveys carried out at different time instances. The aim is to observe changes in the state of the formations and fluids consequent upon production of hydrocarbons from or the injection of fluids into a reservoir. Proper detection of the changes and proper identification of the effects, factors and processes requires specialised acquisition techniques and data processing steps.

Such techniques applied to detect 4D changes are hereafter referred to as warping. The data within the seismic data sets are first processed to compensate for variations in acquisition (or non-repeatability of seismic surveys) and changes in velocity in the sub-surface. The standard technique makes use of cross-correlation between different surveys in selected windows. Such a window is a time interval representing a portion of a trace. One problem with these correlation-based approaches is the size of the correlation window. If the window used for correlation is too large, the accuracy of correlation is likely to be affected: indeed, the correlation value will then depend not only on differences between the survey at the point being considered, but also on other effects, apart from the points being considered. If the window used for correlation is too small, correlation is likely to be severely affected by noise and non-repeatability of the surveys, including changes due to the effects whose observation is desired.

J. E. Rickett & D. E. Lumley, Cross-equalization data processing for time-lapse seismic reservoir monitoring: A case study from the Gulf of Mexico, Geophysics, vol. 66 no. 4 (July-August 2001), pp. 1015-1025 discusses the problem of non-repeatable noise in seismic surveys carried out over time. This document discloses the matching of two actual surveys. Pre-migration data were not available. Matching of surveys includes matched filtering, amplitude balancing and warping. This kind of warping consists in cross-correlating traces within windows to assess movements in x, y and t adapted to optimise matching of data between surveys.

Hall et al., Cross-matching with interpreted warping of 3D streamer and 3D ocean-bottom-cable data at Valhall for time-lapse assessment, Geophysical Prospecting, 2005, 53, pp. 283-297 discloses cross-matching of legacy streamer data and newer 3D ocean-bottom cable data, for time-lapse analysis of geomechanical changes due to production in the Valhall field. This document is directed to using results provided by different acquisition methodologies—in the example of the Valhall field, 3D streamer data and 3D ocean-bottom cable. The document indicates that similar migration schemes were used for both surveys. The process involves the steps of
volumetric shaping, to take into account the different acquisition methodologies;
amplitude balancing within and between volumes;
spectral shaping;
global cross-matching, using a locally derived operator.
   Spatial shifts between the two surveys are resolved using 3D warping, in an iterative process centred on interpreted horizons, with interpolation between them.

These documents of the prior art teach warping, the realignment of the seismic surveys being compared for compensating both faults in acquisition (or non-repeatability of seismic surveys) and changes in velocity in the sub-surface.

In EP 1 865 340 to the Applicant, and incorporated herein by reference, the evolution of an oil reservoir in the process of producing is carried out by jointly inverting for the changes in the propagation times and seismic amplitudes of a seismic wavelet along propagation paths in the ground. Inverting allows to back filter, in effect, deriving the original from the solution. A base survey of the reservoir is provided, with a set of seismic traces at a first time T associated to a first velocity field V_{b} ; a monitor survey of the reservoir is provided, the monitor survey being taken at a second time T+Δ T, with a set of seismic traces associated to the same positions as in the base survey; the monitor survey is associated to a second velocity field Vₘ. For a set of samples i in the base survey, one computes over the samples of the set the sum S of a norm of the difference between
the amplitude bᵢ of the seismic trace in the base survey at each sample i and
the sum of the amplitude m_{i′} of the seismic trace at a time-corresponding i′ in the monitor survey and the amplitude due to the reflectivity change local to the time-corresponding sample i′ induced by the difference between the first velocity field V_{b} and the second velocity field Vₘ; the time-corresponding sample i′ being shifted in time by a time-shift derived from the velocity changes along the propagation path from the surface to time-corresponding sample i′. This sum is minimised to derive the velocity changes from the base survey to the monitor survey and thus characterise the evolution of the reservoir.

This analysis is based on the fact that changes in the reservoir, due to exploitation, will cause changes to the petrophysical properties of the rock and therefore to the seismic velocity field. Practically, oil will be substituted by gas or water and/or the fluid pressure will change, modifying saturation, porosity, permeability and pressure, and consequently in velocity. Changes within the reservoir may also perturb the stress and strain state of the surrounding rocks, further altering their velocities. These changes to velocity will produce time shifts in the seismic response of underlying reflectors and associated changes in reflectivity, causing an alteration of the local wavefield. By using an inversion technique, for every point in the 3D volume, an estimate of the 4D changes having occurred in the time lapse between collection of the base and monitor surveys is provided. It is therefore possible to deduce a field of 4D velocity changes without having to proceed with cross correlation of the traces.

Although the 4D inversion problem seems rather easy to formulate as the minimisation of a difference between base and monitor seismic data, it is an ill-posed problem that has multiple solutions: for instance, any smooth zero-mean velocity changes map into zero time-shift and does not generate any 4D amplitude difference. Moreover the inversion becomes even more highly non-linear for fields that induce subsidence and have potentially large time shift.

In EP 1 865 340, the crucial step is in minimising the difference between a base and a monitor seismics. Essentially this is an optimisation problem which requires minimising of the objective function or cost function over all choices of variables i.e. velocity changes that satisfy the modelled constraints. In warping, the cost function can typically be derived as

$$C = {\sum }_{i = 1}^{N} {( b ( {t}_{i} ) - m ( {t}_{i} - {t}_{s} {\sum }_{k = 1}^{i} \frac{Δ V}{V} ( k ) ) + {( w ( t ) * \frac{Δ V}{V} ( t ) )}_{i} )}^{2} \qquad ( 1 )$$

where b and m are respectively the base and the monitor trace, t_{S} is the sampling rate of the seismic data,

$$\frac{Δ V}{V}$$

is the relative velocity 4D change, w is the seismic wavelet and * denotes the convolution between the wavelet and the relative velocity change to model the 4D amplitude change. Usually the cost function is computed over all the available time-samples but it can be also calculated for decimated time samples or the sample number can be increased by interpolation to improve the accuracy of the solution. Moreover, the inversion could be carried out for the most relevant layers of the field (including overburden, reservoir, and underburden) obtained using stratigraphic information or any other strategy. The advantage of working with sub-samples is that it can make the inversion better posed.

However, as in almost any inverse problem, this cost function does not go identically to zero. In fact the forward model used for this inversion, is just an approximation of only the vertical propagation that, although good, implies some assumptions and therefore a residual still exists. In using only data relating to vertical propagation, the solution is less constrained and therefore requires a lot of interpretation and can be unstable and qualitative. Moreover noise remains a major factor which ideally should be reduced.

To partially overcome this problem a regularisation term is added to the cost function. However, it is difficult to choose the optimal weight of this term with respect to the one given by equation 1. Several strategies can be used (Grandi et al., 2009, Quantitative 4D time lapse characterisation: Three examples. Society of Exploration Geophysicists, Expanded Abstracts, 28, no. 1, 3815-3819) and a lot of interpretation is required, meaning that the solution is not unique.

There is still a need for a process for characterising the evolution of a reservoir in time, which could mitigate one or more of these problems.

In an embodiment, the invention therefore provides process for characterising the evolution of a reservoir in the process of producing by co-analyzing the changes in the propagation times and seismic amplitudes of seismic reflections, comprising the steps of:

providing a base survey of the reservoir with a set of seismic traces at a first time;

providing a monitor survey of the reservoir, taken at a second time, with a set of seismic traces associated to the same positions as in the base survey;

characterising the evolution of the reservoir by inverting to obtain an estimate of the changes having occurred in the time interval between base and monitor surveys,

wherein said inversion is performed using at least some seismic traces for which no assumption is made that the energy is propagating only vertically.

Other independent features are as claimed in the appended dependent claims.

### BRIEF DESCRIPTION OF THE DRAWINGS

Embodiments of the invention will now be described, by way of example only, by reference to the accompanying drawings, in which:

FIG. 1 is a schematic view of a seismic block, showing one trace only for the sake of clarity;

FIG. 2 is a flowchart of a process in one embodiment of the invention;

FIG. 3a shows the evolution of a reservoir obtained inverting prestack data, and

FIGS. 3b-3d shows the evolution of a reservoir obtained inverting data from the near offset gather, mid offset gather and far offset gather respectively.

### DETAILED DESCRIPTION OF THE EMBODIMENTS

In the rest of this description, one will use the terms “base survey” and “monitor survey” or just “base” and “monitor” for designating the seismic surveys of the reservoir. The assumption is that the base survey is carried out earlier in time than the monitor survey.

As with EP 1 865 340, the methods described herein are based on the fact that changes in the reservoir, due to exploitation, will cause changes to the velocity field. Practically, oil will be substituted by gas or water and/or the fluid pressure will change, altering density and moduli, and thus changes in velocity. Changes within the reservoir may also modify the stress and strain state of the surrounding rocks, further causing perturbations in their velocities. These changes to velocity will produce time shifts in the seismic expression of underlying reflectors and associated changes in reflectivity, causing a change in the local waveform. In one embodiment, these effects are assessed in the monitor survey. This makes it possible to deduce from the comparison of the base and monitor survey a field of velocity changes, without having to proceed with cross correlation of the traces.

For the sake of facilitating computation, it is advantageous to assume that the time shifts come uniquely from velocity changes; this assumption, when not fulfilled, can be avoided by inverting for time strain that is given both by compaction and velocity effects (Grandi et al., 2009, Quantitative 4D time lapse characterisation: Three examples. Society of Exploration Geophysicists, Expanded Abstracts, 28, no. 1, 3815-3819) instead of inverting solely for the relative velocity change. We also assume that changes in acquisition or processing parameters are negligible. The latter assumption is increasingly fulfilled in modern, dedicated 4D surveys. Previous formulations of the warping inversion (EP 1 865 340) were assuming velocity changes linearly correlated to impedance changes through a coefficient called impedance factor. It was implicitly assumed that there were either no density effects or that the density effects were linearly correlated to velocity effects. In the case where density changes are statistically correlated with the velocity changes, the reflectivity term may be scaled accordingly. For example, if there is a positive correlation such that, on average, a 1% change in velocity implies a 0.25% change in density, the reflectivity term could be scaled by a factor 1.25 so as to give the most probable representation of the change in the trace resulting from the velocity perturbation.

The assumption of a linear correlation between 4D velocity and density changes is correct only when the changes in density are relatively small, i.e. when the pressure effects are the dominant time lapse phenomenon and pressure is above bubble-point; however in many situations pressure is below bubble-point and gas comes out of solution, and the changes in density are related to velocity changes by highly non-linear relations (Rock Physics Handbook, April 1998, Mavko, G., Mukerji, T., and Dvorkin, J., Cambridge University Press). High temperature changes are another source of non-linearity when they modify the fluid properties, as happens in heavy oil fields where there are gas combustions of steam injections. Particular embodiments described herein enable this assumption to be dispensed with by jointly inverting for velocity and density changes, which can therefore be independent.

A major drawback with the prior method of EP 1 865 340, is that it relies on the assumption that the effective reflection angle is small (and/or the expected changes in the shear-wave velocity are also relatively small) and therefore only data relating to vertical (or near vertical waves) are considered. However, it would be advantageous to make use of all the seismic data, and not just the traces that propagate vertically. Consequently, the methods described herein propose performing 4D warping techniques using prestack data, which is data gathered over a wide range of angles or offsets. In conventional practice, data over the full range of angles are split into “data gathers”, or ranges. The number of angle gathers depends on many factors, for example: the acquisition parameters (in particular of the maximum offset that is acquired), the depth, and the seismic data quality. Often the data are split in three angle gathers, usually designated as “near”, “mid” and “far” (this terminology referring to the offset distance between emitter and receiver).

For the reasons above, the method of EP 1 865 340 is only properly applicable for analysing time warping of the near offset substack, while the methods described herein can use prestack data from all available data gathers without any limitation on the number of gathers that can be used. However, modelling the 4D reflectivity change may present difficulties, when using assumptions that limit the maximum incidence angle. The results herein discussed were obtained by the Aki & Richards approximation which has been found accurate for any angle below the critical angle, when used for 4D applications. In any case, any other reflection coefficient approximation could be used instead, if better adapted to 4D applications.

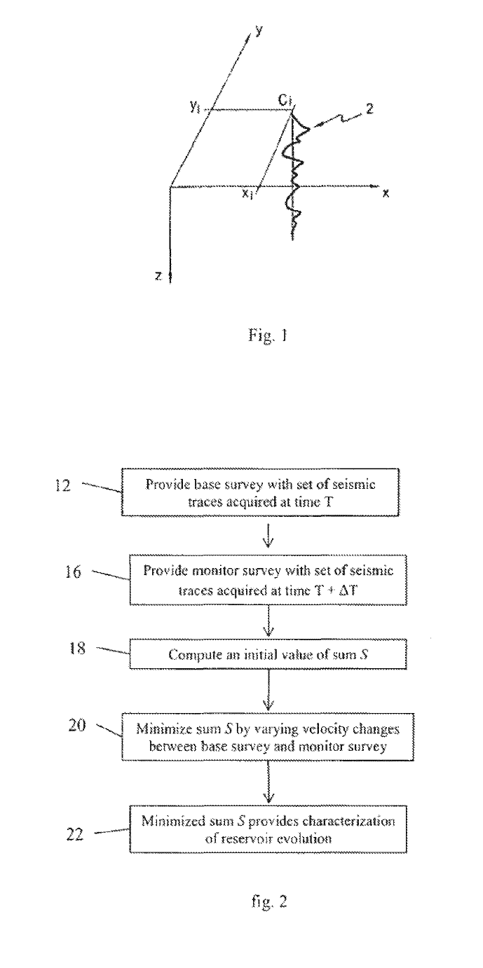

FIG. 1 is a schematic view of a seismic block, showing one trace only for the sake of clarity. The term seismic block is used for describing a set of measurements, over a given geographical field, after processing to produce an image of the earth. As known per se, an orthogonal and normalized set of coordinates is used, in which the x and y axes lie in the horizontal plane. The z-axis, which can correspond either to time or depth, is vertical and oriented downward. As usual for seismic surveys, one uses the coordinates (x, y, t) for a temporal representation of the survey, or the coordinates (x, y, z) after depth migration to a spatial representation of the survey. A set of sensors Cᵢ are placed on the ground or at sea, in points of spatial coordinates (xᵢ, yᵢ, zᵢ), i being an integer representative of the sensor number. In marine acquisition, the sensors may be hydrophones in streamers which are typically towed at 5-7m depth; alternatively receiver cables may be placed on the ocean bottom; even land geophones may sometimes be buried a few metres deep.

When a survey is carried out, a raw signal is recorded on each sensor Cᵢ; this raw signal is representative of the seismic waves reflected by the various interfaces in the sub-surface. Raw signals received on sensors are then processed to provide an image of the sub-surface comprised of a collection of seismic traces grouped into angle gathers, with each gather migrated or “flattened” so that all the traces from a single gather are manipulated to compensate for the angle variations in each gather (residual move out), effectively giving each trace in a gather the same offset.

FIG. 1 shows the axes x, y and t (or z) of the set of coordinates, as well as one sensor Cᵢ with the corresponding trace, referenced 2 on the figure. For the sake of clarity, FIG. 1 only shows one sensor and one trace, while a survey would typically involve many sensors and a number of traces higher than one million. As known per se, seismic processing will place the seismic events as accurately as possible in their true lateral positions. Details on these techniques are available in Özdogan Yilmaz, Seismic Data Processing, Society of exploration Geophysicists, 1987.

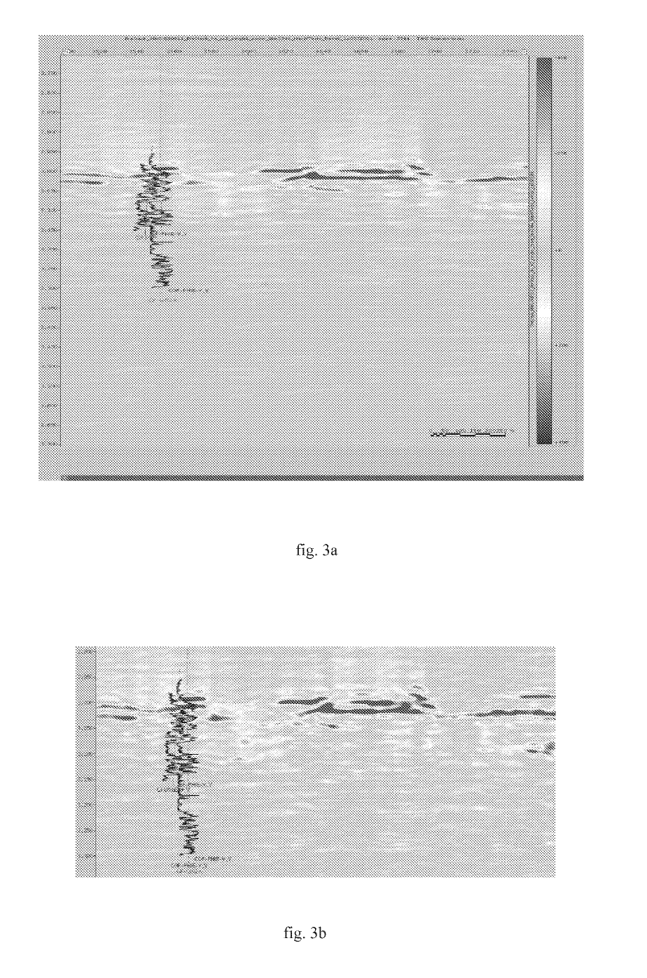

FIG. 2 is a flowchart of a process according to one embodiment of the invention. In step 12, there is provided a base survey of the reservoir, with a set of seismic traces at a first time T. For a given trace, the base survey provides an amplitude b(t), that is an amplitude which is a function of time t; with digital recording and processing the trace is sampled at a sampling period tₛ. Typical trace lengths correspond to around 2000 samples at a 2-4 ms sampling period. The trace can then be handled as a set of values.

At step 16, a monitor survey of the reservoir is provided, taken at a second time T+dT, with a set of seismic traces. In the simplest assumption, T is a positive quantity, and the monitor survey is taken at a time later than the base survey; however, the order in which the surveys are taken is irrelevant to the operation of the process and, in principle, the time lapse T could as well be negative−which amounts to comparing the earlier survey to the later one. As for the base survey, a sampled trace in the monitor survey can also be represented as a set of values m(ti) or mi.

Ideally, the traces in the monitor survey are associated to the same positions as in the base survey. This is carried out by using, inasmuch as possible, the same equipment, acquisition geometry and processes for running the base survey and monitor survey. Practically speaking, a difference of 5-10 m between the positions of sources and receivers still leads to acceptable results. Techniques such as interpolation may be used in case traces in the monitor survey and in the base survey do not fulfil this condition (Eiken, O., et al., 2003, A proven method for acquiring highly repeatable towed streamer seismic data, Geophysics, 68, 1303-1309).

In this embodiment, the relative velocity change

$$\frac{Δ {V}_{P}}{{V}_{P}}$$

is estimated, and is derived from the difference of the base and monitor p-wave velocities, ΔVₚ divided by the base P-wave velocity V_{P}. As an alternative, it is also possible to invert for the p-wave slowness change, n, where slowness is the reciprocal of the velocity giving the relation

$$\frac{Δ {V}_{P}}{{V}_{P}} = - n .$$

This relative slowness change, n, may be assessed in each sample of the seismic block, that is in each sample of a trace. For estimating the relative slowness change, one uses optimization over a set of points, using the cost function equation below.

$$C = {\sum }_{t = {t}_{0}}^{{t}_{f}} {( b ( t ) - m ( t - {t}_{s} {\sum }_{τ = {t}_{0}}^{t} \frac{Δ {V}_{P}}{{V}_{P}} ( τ ) ) - α ( ϑ ) \dot{w} ( t ) * \frac{Δ {V}_{P}}{{V}_{P}} ( t ) )}^{2} \qquad ( 1 )$$

The first term is the amplitude of the base trace data at time t and the second term is the amplitude of the monitor trace data at time t+Δt, where

$$Δ t = - {t}_{s} {\sum }_{τ = {t}_{0}}^{t} \frac{Δ {V}_{P}}{{V}_{P}} ( τ )$$

and is the time shift between time-corresponding points on the base and monitor traces, this time shift being induced by velocity changes in the base and monitor traces. Strictly speaking, the time shift is the integrated change of slowness over the path followed by the signal from the source to the sample being considered and back. The third term is representative of the amplitude perturbation resultant from the local change of reflectivity, consequent upon the velocity change, on the trace. In this third term, local change is considered in a time range commensurate to the wavelet, that is in a time range equal to the duration of the wavelet.

This equation may be simplified as:

$$C = {‖ b - M ( m , \frac{Δ {V}_{P}}{{V}_{P}} ) - α ( ϑ ) W \frac{Δ {V}_{P}}{{V}_{P}} ‖}_{2}^{2} \qquad ( 2 )$$

and following linearization, can be approximated to:

$$C = {‖ b - ( M + α ( ϑ ) W ) \frac{Δ {V}_{P}}{{V}_{P}} ‖}_{2}^{2} \qquad ( 3 )$$

At step 20, this equation is minimised by varying the modelled velocity for every sample in a selected window containing all the 4D effects.

In step 16 of the process of FIG. 2, a set of points is selected; the sum S will be minimized on this set of points. According to computational resources, one may vary the size of the set of points, but these will normally be chosen to completely include the full volume of the reservoir under consideration. In the examples provided below, the traces from the entire base and monitor surveys, windowed in time to span the reservoir, are used. This will provide values of velocity changes over the complete surveys.

In step 18 of the process, an initial value of the sum C is computed.

In step 20 of the process, the equation (3) minimized, by varying the values of the modelled relative velocity changes—expressed as the relative velocity change (or expressed also as the relative slowness changes). This provides a field of velocity changes, for the various points. The field of velocity changes parameterises a warping operation for shaping the monitor survey with the base also characterizing the evolution of the reservoir.

One example of an optimization technique is provided below; however, one may also use other optimization techniques known per se in the art, such as simulated annealing. If, as suggested above, the seismic events in the monitor survey are not displaced laterally from their positions in the base survey, points are only time-shifted. One may then carry out the computation on a trace-by-trace basis; in other words, optimization may be carried out separately on each trace. This simplifies computation and makes it easier to run the optimization step as parallel tasks on a number of computers.

In step 22, the minimum of sum C has been attained, and this provides a value of velocity change for the various points of the set of points over which the optimization was carried out. The field of velocity changes associated with the minimum of the sum C, characterizes the evolution of the reservoir over time.

Minimization in step 20 may be carried out using the Gauss-Newton formula. The Gauss-Newton formula is known per se.

Much of the above method differs little from EP1 865 340. However, this method can be performed upon pre-stack data over the full range of incident angles. This is as a result of the α(θ) function in the reflectivity term of the above cost function.

This function can be ignored when only considering vertically propagating waves as in the prior art. This function is dependent on the angle of incidence of the seismic waves on the seismic event from which it reflects. As is known from the Aki and Richards equations, this function equals:

$$α ( ϑ ) = \frac{1}{2} ( 1 + {tan}^{2} ( ϑ ) ) \frac{Δ {V}_{P}}{{V}_{P}} \qquad ( 4 )$$

It should be noted that, in contrast to the formulation of Aki & Richards, the velocity change in eq (4) is a 4D change between P-wave velocities of base and monitor and not the difference between velocities of two layers at different depth. It should also be noted that this is only one example and that, in fact, several other approximations of the reflectivity with respect to the incident angle may be used. Other examples have been tested and gave similar results.

Consequently, the inversion can be performed for each data gather simultaneously, and and the sum of these cost functions minimised to find the velocity changes that warp a monitor trace into the corresponding base. For instance, when three angle gathers (called near (N), mid (M), and far (F)), are available, the cost function can be split into the three parts

$$\begin{matrix}{C}_{N} = {‖ {b}_{N} - ( {M}_{N} + {α}_{N} W ) \frac{Δ {V}_{P}}{{V}_{P}} {\vert}_{N} ‖}_{2}^{2} & ( 5 ) \\ {C}_{M} = {‖ {b}_{M} - ( {M}_{M} + {α}_{M} W ) \frac{Δ {V}_{P}}{{V}_{P}} {\vert}_{M} ‖}_{2}^{2} & ( 6 ) \\ {C}_{F} = {‖ {b}_{F} - ( {M}_{F} + {α}_{F} W ) \frac{Δ {V}_{P}}{{V}_{P}} {\vert}_{F} ‖}_{2}^{2} & ( 7 )\end{matrix}$$

and the cost function is given by the sum of them as

C_{ALL}=C_{N}+C_{M}+C_{F} (8)

It should be noted that the ability to perform the techniques disclosed in EP1 865 340 usefully on mid and far substack data is itself unknown in the prior art, as it relies on the incidence angle function of equations (1) to (3) to calculate the reflectivity term properly. A clear advantage is that it enables the application of 4D warping inversion beneath platforms where near offset traces cannot be acquired, such as for streamer acquisitions.

Several iterations are normally required to reach the final solution, being the warping a non-linear inversion where a time-shift is applied to the monitor trace. Tests carried out by the applicant suggest that convergence will generally be achieved after 4 iterations, although this number is highly dependent on the type of regularisation that is added to the cost function. It is ascertained that the process will converge if the time shifts amount to less than a half-period of the dominant frequency, as will often be the case. Beyond this value, there may be a risk that the Gauss-Newton iteration will converge on a local minimum. The fact that the above embodiment of the process may converge on a local minimum does not invalidate the method, inasmuch as a correct selection of the initial values of the relative slowness changes, using, e.g., a standard correlation method, such that the remaining shifts are less than a half-period, or interpreting and matching major seismic markers in and around the reservoir, will allow its subsequent application. Alternatively, the use of a global optimisation approach will ensure convergence toward the true minimum.

It is sometimes the case that data from one of the gathers is of a superior quality than the others, or that the quality varies between the gathers. In such a situation, one could weight the different gathers in favour of the superior data, or according to their relative accuracies when minimising the cost function shown in equation (8).

Also, it may be that the angle gathers have different frequency contents. For example, the far gather may be a comparatively low frequency weaker signal, than that of the other gathers. One way of addressing this is by using angle dependent wavelets, for each gather in order to compensate. Equations 1, 2, 3, 5, 6 and 7 change accordingly.

While the above largely relates to fluid substitution warping of non-compacting reservoirs, the principles can be extended to compaction warping of compacting reservoirs. The main difficulty is that the time-shift is given by the combination of two effects that are the change in thickness and the change in velocity as

Δτ/τ=Δh/h−ΔV/V

where Δτ/τ is the so called time strain which integral gives the time shift (Hatchell, 2006). Here the term

$$\frac{Δ h}{h}$$

corresponds to the thickness change and can be negative within the reservoir, meaning that the reservoir is compacting due to depletion or can be positive when the overburden (or underburden) expands to accommodate the compaction at the reservoir.

A first formulation of the warping for compacting reservoir is to use the cost function below

$${C}_{ϑ} = {‖ {b}_{ϑ} ( {t}_{i} ) - {m}_{ϑ} ( {t}_{i} + {t}_{S} {\sum }_{j = 1}^{i} \frac{Δ t}{t} ( {t}_{j} ) ) ‖}_{2}^{2}$$

In this case the cost function for a particular angle stack is obtained by the difference of the base and the monitor traces at a given incident angle. Indeed the overall cost function is given by summing together all the contributions from the different angles.

However the inversion can be formulated in order to invert for thickness and velocity changes as

$${C}_{ϑ} = {‖ {b}_{ϑ} ( {t}_{i} ) - {m}_{ϑ} ( {t}_{i} - {t}_{S} {\sum }_{j = 1}^{i} ( \frac{Δ V}{V} ( {t}_{j} ) - \frac{Δ h}{h} ( {t}_{j} ) ) ) - {\vert α ( ϑ ) w ( t ) * \frac{Δ V}{V} ( t ) \vert}_{i} ‖}_{2}^{2}$$

where again the final cost function is given by the sum of all the angle gather contributions.

A better way of formulating the previous equation is to invert for time strain and R factor as

$${C}_{ϑ} = {‖ {b}_{ϑ} ( {t}_{i} ) - {m}_{ϑ} ( {t}_{i} + {t}_{S} {\sum }_{j = 1}^{i} \frac{Δ t}{t} ( {t}_{j} ) ) + {\vert α ( ϑ ) w ( t ) * ( \frac{R ( t )}{1 + R ( t )} \frac{Δ t}{t} ( t ) ) \vert}_{i} ‖}_{2}^{2}$$

where the so called R factor is obtained by assuming a linear relationship between velocity change and compaction (Hatchell, P. J., and Bourne, S. J., 2006, Measuring Reservoir Compaction Using Time-Lapse Timeshifts, EAGE, Expanded Abstracts). The main advantage is that the non-linear part of the cost function is given by just one parameter. This makes the inversion more stable.

Another major advantage of the methods disclosed herein is that they allow not only inversion for p-wave velocity changes over the time interval, but additionally at least one other interval attribute or parameter, such as s-wave velocity (shear) and/or density changes. This can be achieved by extending equation (3) (and the full cost function equations from which it derives) by the addition of terms relating to the density and/or the s-wave velocity.

$${C}_{ϑ} = {‖ {b}_{ϑ} - ( {M}_{ϑ} + α ( ϑ ) W ) \frac{Δ {V}_{P}}{{V}_{P}} - β ( ϑ ) W \frac{Δρ}{ρ} - γ ( ϑ ) W \frac{Δ {V}_{S}}{{V}_{S}} ‖}_{2}^{2} \qquad ( 10 )$$

where similarly to the Aki and Richards equations

α(θ)=½(1+tan²(θ))

and it is assumed γ=V_{P}V_{S}

β(θ)=½(1−4γ sin²(θ))

γ(θ))=−4γ sin²(θ) (11)

It has already been successfully demonstrated that equation (10) can be used to invert for the change in p-wave velocity and change in density together. By the same logic it is assumed that inversion is possible to obtain the change in p-wave velocity and change in s-wave velocity together and even to invert for changes in all three parameters together.

Equation (5) is used as described above, but in this case not only are different values for the p-wave velocity changes substituted in order to minimise the equation, but also values for either the density changes or s-velocity change (or both) as appropriate.

As with many inverse problems, the warping inversion is ill-conditioned, meaning that inversion is done for more parameters than explained by the data. A common way to address this is to regularise the solution. In practise further constraints are added in order to find geologically compatible solutions. Therefore, if C_{S} is one of the cost functions previously discussed, the complete cost function is

$$C = {C}_{S} + {λ}_{1} f ( \frac{Δ {V}_{P}}{{V}_{P}} ) + {λ}_{2} f ( \frac{Δρ}{ρ} ) + {λ}_{3} f ( \frac{Δ {V}_{S}}{{V}_{S}} ) \qquad ( 12 )$$

where every parameter inverted for is regularised. ƒ in equation12 is any function of the parameter and is usually chosen according to the noise type and a priori information such as the thickness and shape of the reservoir.

A major drawback of the method described in EP1 865 340 is that a huge interpretational effort is required in order to find the optimal regularisation weight and therefore to achieve a geologically compatible solution (Grandi et al., 2009, Quantitative 4D time lapse characterisation: Three examples. Society of Exploration Geophysicists, Expanded Abstracts, 28, no. 1, 3815-3819). In this respect the problem as formulated by the previous inversion is better defined as in the prior art as it is dependent on more data, especially when the inversion is performed for the relative change in P-wave velocity. It is also true that the problem is better formulated because it takes into account more parameters. This means that there are less possible (mathematical) solutions that minimise the equation, leading to easier identification of an optimal real-world solution. This is true even when only inverting for one parameter (equations (1) to (3)), as the prestack data used are more detailed and include much more information than using only near stack vertical data, thereby better constraining the solution.

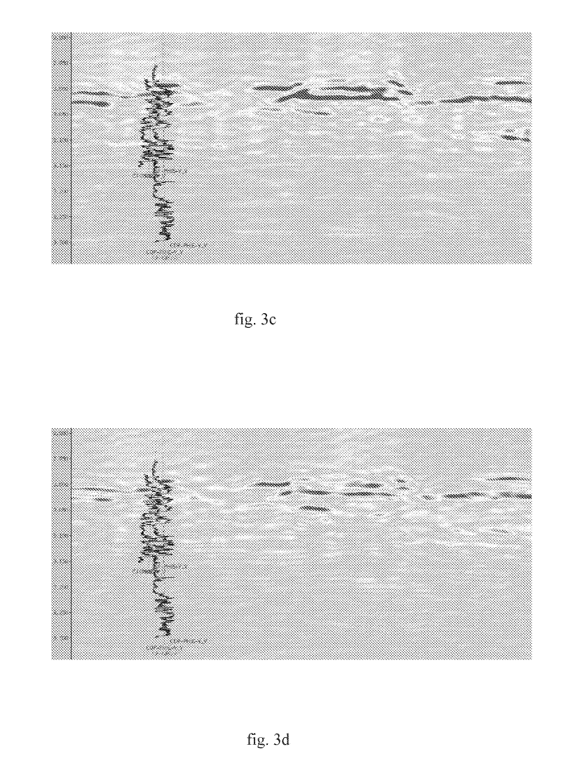

FIGS. 3a-3d highlights the improvements obtained by the above inversion method using pre-stack data. In this case inversion is only being performed for p-wave relative velocity changes. It shows a conventional reservoir seismic image obtained using “near” offset data (FIG. 3b), that is from only waves which are assumed to propagate vertically), as well as similar images using data from the “mid” and “far” gathers (FIG. 3c and FIG. 3d respectively which are obtained using new techniques described herein. It can be seen that these all suffer significantly with noise compared to the seismic image obtained from all three gathers considered together (FIG. 3a), according to an embodiment of the invention. The darker areas of the 4D signal corresponds to velocity reduction due to gas coming out of solution that is the main 4D effect in this part of the field. It can be also noted that the results of FIGS. 3b, 3c and 3d are very similar and therefore show that, after accurate processing, mid and far gathers contain as much information as the near angle gather. It means that the techniques described herein allow useful information to be obtained by warping angle stacks with incidence angles which differ from zero. It can be noted as well that the approximation for the 4D reflectivity is valid also for the far angle stack despite the maximum incidence angle is 34 degrees.

However, a better result is obtained when all the three available angle gathers are used together (FIG. 3a). In this case the signal has a better resolution and the ambient noise is greatly reduced. Finally, because the results are more data-driven than interpretation driven, the solution is more quantitative and unique.

It is also possible to combine the method above with the “multi-monitor” methods described in GB0909599.3, to the applicant and which is incorporated herein by reference. As discussed before, a well known method to deal with approximated forward models and noise is by adding a regularisation term to the cost function. Other techniques are known, but regularisation imposes further constraints on the results and thus avoids overfitting of the data and the noise. In effect we constrain the solution to the point that it does not need to be minimised. The cost function can be considered as the seismic mismatch together with the regularisation:

$$C = {\sum }_{i = 1}^{N} {( b ( {t}_{i} ) - m ( {t}_{i} - {t}_{S} {\sum }_{k = 1}^{i} \frac{Δ V}{V} ( k ) ) + {( α ( ϑ ) w ( t ) * \frac{Δ V}{V} ( t ) )}_{i} )}^{2} + λ {\sum }_{i = 1}^{N} f ( \frac{Δ V}{V} ( {t}_{i} ) ) . \qquad ( 13 )$$

The final term is the regulation term. The regularisation weight λ expresses a trade off between modelling the 4D changes from seismic and imposing constraints on the solutions. There are many forms of regularisation using any function f of the relative velocity change.

Prior to the teaching of GB0909599.3, In order to select the optimal regularisation, a number of steps were performed on the base and monitor seismic survey data:
1. A number of locations or seismic traces are selected representative of the seismic quality;
2. The data in these locations are warped for different regularisation weights;
3. The cost function terms i.e. seismic mismatch are cross-plot against the regularisation term to provide a regularisation weight-map;
4. From a range of valid solutions determined from the plot, the best solution is selected for the regularisation value according to the available production history and geological information of the reservoir.
5. The optimal regularisation values are interpolated across the whole common seismic survey area to obtain the time lapsed seismic image between the base and monitor surveys.

It can be shown that such a cross-plot shows four distinct regions. In a first region there is no solution as the warping is trapped in a local minimum and does not converge. In a second region, there under-regularised solutions are obtained, where perfect fitting of the seismic occurs but the solution is non-physical. In a third region, the balancing between seismic fitting and regularisation is optimal and in a fourth region there are over regularised solutions where the time shift is zero everywhere, the warped trace does not change from the monitor and the difference between warped and base is a constant.

GB0909599.3 improves on this method by using the results of at least two monitor surveys, performed at different exploitation periods of the reservoir, to obtain a cross-plot which only shows values in the third, optimal region. As before, the traces in each monitor surveys are ideally associated to the same positions as in the base survey.

As realised above, to stabilise the solution and to input a-priori information a regularisation term is added to the cost function. Several kernels have been tested and they have to be adapted to the particular shape/bandwidth of the solution and to the level of 4D noise present in the sample. We have considered the classical Tikhonov regularisation in an L1 or L2 norm but other kernels could be used as well. Sometimes more than one term is needed and two of them have to be cascaded. The crucial aspect in this is to select the right regularisation parameter to balance fitting the data and regularising the solution.

In this embodiment, the cost function is modified to accommodate multiple surveys Here b is a first base (reference) seismic trace, and mₙ are subsequent monitor traces, such that the cost function which is inverted during the inversion is simplified as

$$C = ‖ \overline{b} - {\overline{m}}_{1} ‖ \begin{matrix}2 \\ 2\end{matrix} + ‖ \overline{b} - {\overline{m}}_{2} ‖ \begin{matrix}2 \\ 2\end{matrix} + ‖ {\overline{m}}_{1} - {\overline{m}}_{2} ‖ \begin{matrix}2 \\ 2\end{matrix} + ‖ \overline{b} - {\overline{m}}_{3} ‖ \begin{matrix}2 \\ 2\end{matrix} + ‖ {\overline{m}}_{1} - {\overline{m}}_{3} ‖ \begin{matrix}2 \\ 2\end{matrix} + ‖ {\overline{m}}_{2} - {\overline{m}}_{3} ‖ \begin{matrix}2 \\ 2\end{matrix} + … \qquad ( 14 )$$

plus a regularisation part where the 4D changes between any pair of traces are summed. As in the previous formulation, the regularisation part is multiplied by a weight that still expresses the best trade off between fitting the data and imposing constraints on the solution. A shaping operator has been applied to each monitor trace to compensate for time shift and 4D amplitude effects in order to match the base seismic. The vector notation is used to indicate that the cost function is computed along a window big enough to contain a majority of the 4D effects that can occur either in the reservoir or in the overburden in case of stress-sensitive reservoirs, but also small enough to reduce the amount of computation required and to ensure that a majority of the trace represents the 4D effects. It can be helpful to compare traces of different surveys to select an optimum window to use. The formula shows that the cost function minimises the difference between every combination (each of size 2) of the surveys.

Consequently the optimal regularization parameter can now be determined, but the cross-plot derived will now only show values in the optimal region discussed above. Indeed there will be a constrained number of values to select from and, as a result, less a priori knowledge of the production history and geological information is required to derive the optimal regularisation parameter. The parameter could either be the same for every combination of surveys or it may differ if any of the surveys has different features, such as signal to noise ratio, and therefore requires particular care.

The above “multi-monitor” method of obtaining optimal regularisation can be performed on data from just one data gather, for example on only the near data gather. In this case the equation (13) could be used to determine C_{N} in equation (8). Equally, the multi-monitor technique could be performed on each gather or on any 2 gathers.

To summarise the main advantage of using pre-stack information according to the methods disclosed herein is that:
The solution is better constrained as all the available seismic data is made use of (and not just the traces for which the energy propagates vertically).
Inverting is possible for two, and possibly three, parameters making use of AVO (Amplitude Versus Offset−4D changes in P and S velocities+density) and time-shift (4D changes in P-wave velocity alone). For wells with dominant fluid effects, inversion is best performed for P-wave velocity and density changes, and in case of dominant mechanical effects, the two main parameters should be P-wave velocity changes and compaction.
The solution can be made quantitative, the solution being based on much more actual real-world data, and therefore less a priori information is required.

The processes described herein may be embodied in a computer program. The program is adapted to receive data for the base and monitor surveys, as well as data for the velocity fields; such data are in the format provided by state of the art computer packages such as those discussed above. The program runs the various steps of the process of FIG. 2 or else as described herein.

It should be noted that the above examples are for illustration only and that other embodiments and examples can be envisaged without departing from the spirit and scope of the invention.

1. A process for characterising the evolution of a reservoir by co-analyzing the changes in the propagation times and seismic amplitudes of seismic reflections, comprising the steps of:
providing a base survey of the reservoir with a set of seismic traces at a first time;
providing a monitor survey of the reservoir, taken at a second time, with a set of seismic traces associated to the same positions as in the base survey;
characterising the evolution of the reservoir by inversion to obtain an estimate of the changes having occurred in the time interval between base and monitor surveys; and
wherein said inversion is performed using at least some seismic traces for which no assumption is made that the energy is propagating only vertically.

2. The process as claimed in claim 1 wherein said inversion is performed by minimising a function which includes a term dependent on the incident angle of said seismic reflections.

3. The process as claimed in claim 2 wherein the function to be minimised includes regularisation terms to impose constraints on the inverted parameters.

4. The process as claimed in claim 2 wherein the function to be minimised is computed for any set of the seismic data re-sampled in time, including non regular sampling.

5. The process as claimed in claim 1 wherein said function to be minimised is dependent on the relative velocity changes, said function modelling time shifts in the seismic response of reflectors and associated changes in reflectivity between said base survey and said monitor survey.

6. The process as claimed in claim 1 wherein said inversion is carried out for two or more parameters.

7. The process as claimed in claim 6 wherein said two or more parameters include: relative p-wave velocity or slowness change, relative density change and relative s-wave velocity or slowness change.

8. The process as claimed in claim 1 wherein the inversion is performed using the linearised function:
$$C = {‖ b - ( M + α ( ϑ ) W ) \frac{Δ {V}_{P}}{{V}_{P}} - β ( ϑ ) W \frac{Δρ}{ρ} - γ ( ϑ ) W \frac{Δ {V}_{S}}{{V}_{S}} ‖}_{2}^{2}$$
where b is the base survey data, M is the monitor survey data α(θ), β(θ) and γ(θ) are functions dependent on the incident angle at reflection, W is a matrix taking into account the derivative of the wavelet, Vₚ is the p-wave velocity, ρ is the density and Vₛ is the s-wave velocity, and wherein one or both of the last two terms may be ignored as appropriate when inversion is not being performed for density and/or s-wave velocity.

9. The process of claim 1 wherein said inversion is carried out for time strain.

10. The process of claim 1 wherein said reservoir is of the compacting type and said inversion is carried out for thickness changes and velocity changes.

11. The process of claim 10 wherein said inversion is carried out for time strain and R factor or any other term relating the ratio between velocity changes and thickness changes.

12. The process as claimed in claim 1 wherein said traces are grouped according to said incident angles, said data being manipulated to compensate for residual move out, said inversion being performed on pre-stack data comprising at least two of said groups.

13. The process as claimed in claim 12 wherein the groups are differently weighted according to their signal to noise ratio or any other attribute related to their quality.

14. The process as claimed in claim 1 wherein a plurality of monitor surveys is provided, said inversion being performed for said plurality of monitor surveys.

15. The process as claimed in claim 1 further comprising the step of using the resultant data to aid hydrocarbon recovery from said reservoir.

16. Apparatus specifically adapted to carry out the all the steps of any of the processes as claimed in claim 1.

17. A computer program residing on a computer-readable medium, comprising computer program instructions which, when run on a computer, causes the steps of the process of claim 1 to be performed.
